(19) United States
(12) Patent Application Publication
(10) Pub. No.: US 2021/0140455 A1
(43) Pub. Date: May 13, 2021

(54) APPARATUS AND METHOD FOR ANCHORING FASTENERS

(71) Applicant: Geolyn Holdings LLC, Northport, NY (US)

(72) Inventors: Nicholas Andrew Zacpal, West Islip, NY (US); Lynda Lee Zacpal, Brightwaters, NY (US); George William Hugues, Northport, NY (US)

(21) Appl. No.: 17/070,517

(22) Filed: Oct. 14, 2020

Related U.S. Application Data
(60) Provisional application No. 62/914,671, filed on Oct. 14, 2019.

(51) Int. Cl. F16B 5/02; F16B 37/04

(52) U.S. Cl. CPC F16B 5/0275; F16B 37/04

(57) ABSTRACT

An apparatus for anchoring fasteners includes a shaft, a guide disk and a flange. The shaft extends in an axial direction between a proximal end and a distal end. The shaft has an internally threaded axial bore, and at least one outer surface thread. The guide disk is disposed at the distal end of, and coaxially with, the shaft. The first disk has a first diameter that is less than a major diameter of the at least one outer surface thread, and greater than a minor diameter of the at least one outer surface thread. The flange is disposed at the proximal end of the shaft, and has a width exceeding the first diameter. The flange includes a drive feature configured to engage a drive tool.

This application claims the benefit of U.S. provisional patent application Ser. No. 62/914,671, filed Oct. 14, 2019, the entirety of which is incorporated herein by reference.

### TECHNICAL FIELD

The disclosure relates generally to anchoring fasteners into materials.

### BACKGROUND

In order to attach objects to a surface of a wall or other device, it is often necessary to use a fastener anchor in the material. For example, a drywall anchor is a fastener designed to provide a strong connection when using screws to hang items pictures, mirrors, clocks and shelving when a solid stud is not available. Fastener anchors are also often used for using fasteners in concrete.

In materials such as plastic or metal, anchoring fasteners can involve drilling a hole and utilizing a tap to fabricate threads inside the drilled hole. There exist American and metric standards for drill and tap sizes that have existed for decades. Normally, the tapped holes are fabricated into the plastic, and then a normally threaded bolt or screw can be rotatably inserted into the tapped hole. Some metal screws have eccentric thread forming features that can be used to form threads directly into a softer plastic material, in a self-tapping manner.

One limitation of these types of thread forming screws is the necessity for deep blind hole which is molded or drilled into the plastic as a receptacle for the thread forming screw. A common thread-forming screw diameter-to-hole length ratio is 1:5, which allows for suitable anchoring. This limitation is due to the softer plastic, which requires several threads to anchor the screw.

Such methods can be unsuitable for engineered materials, including Kevlar reinforced engineered materials and others produced by fused deposition modeling (FDM). Parts constructed of these materials are printed and are normally thin-walled to mimic a plastic injection molded part. Because of the thin walls, minimal threads can be used, which decreases the holding force. In many instances, the threaded shaft extends into the material to a depth that is less than the diameter of the screw itself. As such a fastener on a thin-walled part will pull out almost immediately if any substantial torque is applied which translates into axial holding force.

Another technique used to fasten parts together relies on both parts being of similar metals that can be brazed or welded together. Engineering thin-wall parts can be attached together in this way, but both must be metallic in nature.

There exists a need, therefore, for a new attachment method and related apparatus that can attach high performance Kevlar material, thin-walled materials such as FDM printed parts, injection molded parts, yet behave similarly to a tapped metallic hole.

### SUMMARY

At least some embodiments disclosed herein address the above-stated need, as well as others by providing a fastener anchor that includes an internally threaded shaft having external threads, a guide disk and a flange. The combination allows for a controlled insertion of the anchor such that the external threads reliably grip the anchored material, and resists translation of non-axial forces to axial separation force. Such a device and method can also provide advantages in anchoring to human and animal bone tissue.

A first embodiment is an apparatus for anchoring fasteners that includes a shaft, a guide disk and a flange. The shaft extends in an axial direction between a proximal end and a distal end. The shaft has an internally threaded axial bore, and at least one outer surface thread. The guide disk is disposed at the distal end of, and coaxially with, the shaft. The first disk has a first diameter that is less than a major diameter of the at least one outer surface thread, and greater than a minor diameter of the at least one outer surface thread. The flange is disposed at the proximal end of the shaft, and has a width exceeding the first diameter. The flange includes a drive feature configured to engage a drive tool.

A second embodiment, is a method of providing an anchor for a threaded fastener in an anchoring material. The method includes forming a first bore in the anchoring material having a first diameter, and inserting at least a guide disk of an anchoring apparatus into the first bore. The guide disk has substantially the first diameter. The anchoring apparatus further includes a shaft having at least one outer surface thread and an axial bore with interior threads. The outer surface thread has a major diameter that exceeds the first diameter. The method also includes rotatably inserting the shaft such that the at least one outer surface thread self-taps into the anchoring material. The method further includes rotatably inserting the threaded fastener into the axial bore.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows a perspective view of an apparatus for anchoring fasteners and a fastener configured to be anchored by the apparatus;

FIG. 2 shows a side plan view of the apparatus and the fastener of FIG. 1;

FIG. 3 shows a logical flow diagram of an exemplary embodiment of a method for anchoring a fastener;

FIG. 4 shows a perspective view of the anchoring apparatus of FIG. 1 being inserted into an anchoring material;

FIG. 5 shows a perspective view of the anchoring material of FIG. 4 with the anchoring apparatus and fastener of FIG. 1, and a material to be anchored;

FIG. 6 shows a cutaway side view of the anchored material of FIG. 5 anchored to the anchoring material by the fastener and the anchoring apparatus of FIG. 1; and

FIG. 7 shows a side plan view of an alternative embodiment of an anchoring apparatus.

### DETAILED DESCRIPTION

For the purposes of promoting an understanding of the principles of the invention, reference is made to selected embodiments illustrated in the drawings and specific language will be used to describe the same. It will nevertheless be understood that no limitation of the scope of the invention is thereby intended; any alterations and further modifications of the described or illustrated embodiments, and any further applications of the principles of the invention as illustrated herein are contemplated as would normally occur to one skilled in the art to which the inventions relates. At least one embodiment of the invention is shown in detail, although it will be apparent to those skilled in the relevant art that some features or some combinations of features may not be shown for the sake of clarity.

Any reference to “invention” within this disclosure is a reference to an embodiment of a family inventions, with no single embodiment including features that are necessarily included in all embodiments, unless otherwise stated. Furthermore, although there may be references to “advantages” provided by some embodiments of the present invention, other embodiments may not include those same advantages, or may include different advantages. Any advantages described herein are not to be construed as limiting to any of the claims.

FIG. 1 shows a perspective view of an apparatus 10 for anchoring a fastener, as well as a fastener 102 configured to be anchored by the apparatus 10. FIG. 2 shows a side plan view of the apparatus 10 and the fastener 102. With reference to FIGS. 1 and 2, the apparatus 10 includes a shaft 12, a guide disk 14 and a flange 16. The shaft 12, guide disk 14 and flange 16 in this embodiment are formed of metal and may be formed integrally together. However, it will be appreciated that the apparatus 10 can be manufactured from ferrous, non-ferrous and super alloy materials, and may be fabricated from metal deposition on sintering processes which are heat treated to fuse the atomic structure and provide a metallic part.

The shaft 12 is disposed about an axis R and extends in the axial direction (along the axis RI) between a proximal end 18 and a distal end 20. The shaft 12 includes an internally threaded axial bore 22 with internal threads 24, and has at least one external cutting thread 26. The internal threads 24 are configured to receive a standard SAE threaded fastener. Accordingly, the fastener 102 in this embodiment is a bolt having a head 104, and a shaft 106. The fastener shaft 106 has threads 107 in any suitable thread arrangement such as a standard SAE thread size.

The external cutting threads 26 are threads that define a major diameter fw, and a minor diameter gw. The In the exemplary embodiment of FIGS. 1 and 2, the external cutting threads 26 are formed of two threads 26a, 26b. It will be appreciated that more or threads may be used if desirable for the application. A single thread could be used if necessary due to depth limitations. In general, the external cutting threads 26 are configured (at least by material hardness, dimension and number of threads) to cut into one or more materials in which the anchoring apparatus 10 is intended to anchor. Each of the threads 26a, 26b, in this embodiment is eccentric with respect to the axis R, which improves the axial pull-out strength. However, in other embodiments, the threads 26 may be concentric, and may or may not have variable pitches.

FIG. 7 shows an alternative embodiment of the apparatus 10′ having generally the same structure as the apparatus 10, but a shaft 12′ having cross-cut eccentric threads 26′. The cross-cuts 27 permit thread locking compound to be utilized to solidify the eccentric thread-to-material bond when the apparatus 10′ is installed into an anchoring material. The apparatus 10′ also has a modified guide disk 14′, as will be discussed further below.

Referring again to the embodiment of FIGS. 1 and 2, the guide disk 14 in this embodiment provides mechanical means to self-center the anchoring fastener within a drilled hole, as, will be discussed below in connection with FIGS. 3 to 6. The guide disk 14 is a substantially cylindrical disk rigidly affixed to the distal end 20 of the shaft 12. The guide disk 14 is arranged coaxially with the shaft 12, and has a first diameter sw that is less than the major diameter fw of the one outer surface threads 26, and greater than the minor diameter gw of the outer surface threads 26. The guide disk 14 extends in the axial direction from the distal end 20 of the shaft 12 by its axial height or length. Then axial length exceeds the pitch of the outer surface threads 26.

In the alternative embodiment of FIG. 7, the guide disk 14′ includes an annular chamfered leading edge 14a′, which assists in inserting the guide disk 14′ into a hole in the anchoring material. As also shown FIG. 7, the guide disk 14′ can include a plurality of holes or voids 14b′ to allow the addition of bonding material such as bone cement in medical applications. For reasons that will be discussed below, the axial height of both guide disks 14, 14′ are preferably at least about one-fourth of the first diameter sw. This ratio allows for reliable self-centering functioning of the guide disks 14, 14′.

Referring again to the embodiment of FIGS. 1 and 2, the flange 16 is disposed at the proximal end 18 of the shaft 12. The flange 16 in this embodiment also comprises a disk disposed concentrically about the axis R. The flange 16 has a diameter dw that exceeds the first diameter sw of the guide disk 14. However, it will be appreciated that the flange 16 may be non-circular in some embodiments. In such embodiments, the width (perpendicular to the axis R) of the flange 16 exceeds the first diameter sw. As will be discussed below, the flange 16 serves to provide a surface designed to distribute stress load transfer across the face of the flange as well as reinforce the anchor apparatus 10 against failure due to torque. The flange 16 has a proximal surface 30 and an axial height that extends from the proximal end 18 of the shaft 12 to a proximal surface 30.

Regardless of the shape, the proximal surface 30 of the flange 16 includes a drive feature 28 configured to engage a drive tool. For example, as shown in FIG. 1, the drive feature 28 comprises in this embodiment includes a shaped recess in the proximal surface 30, which can be a standard hex drive socket. The minimum width of the drive feature 28 exceeds the diameter of the axial bore 22. It will be appreciated that the drive feature 28 can take other forms, such as drive feature that extends proximally away from the proximal surface 30. In such a case, the drive feature would have an interior bore that aligns with the bore 22.

The use of an anchoring apparatus according to embodiments of the invention is described with respect to the embodiment of the apparatus 10 described above. However, it will be appreciated that the method described herein can be carried out with other devices consistent with the description below, including but not limited to the anchoring apparatus 10′ of FIG. 7. Moreover, the method described herein relates to use of an anchor apparatus to join one substrate to another substrate. It will be appreciated that the anchor apparatus and method describe herein may be used to anchor a fastener alone, or for use with something other than substrate.

FIG. 3 shows a logical flow diagram of an exemplary embodiment of a method 200 for anchoring a fastener. The method of FIG. 3 is described with respect to the anchoring apparatus 10 of FIG. 1 in connection with FIGS. 4 to 6. FIG. 4 shows a perspective view of the anchoring apparatus 10 of FIG. 1 being inserted into an anchoring material 110. FIG. 5 shows a perspective view of the anchoring material 110 with the anchoring apparatus 10, the material 120 to be anchored, and the fastener 102. FIG. 6 shows a cutaway side view of the anchored material 120 anchored to the anchoring material 110 by the fastener 102 and the anchoring apparatus 10. The anchoring material 110 in this embodiment is a wall or substrate that is constructed of high performance FDM materials, Kevlar reinforced engineered materials or injection molded parts. However, in other embodiments, the anchoring material may be bone tissue of a human being or animal.

Referring to FIG. 3, in step 202, a bore is formed in the anchoring material. In the example of FIGS. 4 and 6, the bore 112 is formed in the anchoring material 110. The bore should extend axially into the anchoring material 110 by a length defined by the axial length of the shaft 12 and the axial length of the guide disk 14. The bore 112 has a diameter that is substantially the same, or slightly larger, than the diameter bw of the guide disk 14. More specifically, the bore 112 is configured such that the guide disk 14 fits tightly within the bore 112, and can only move axially and/or rotationally. In other words, the center axis of the guide disk 14 does not skew from aligning with the axis R.

In this embodiment, a countersink depression 114 is also formed. The countersink depression 114 is formed coaxially about the bore 112, and has a diameter that is substantially the same as, or slightly larger than the diameter dw of the flange 16. The countersink depression 114 furthermore has a depth that corresponds to the axial depth of the flange 16.

Referring again to the general method of FIG. 3, in step 204, the guide disk 14 is inserted into the bore 112. The guide disk 14 is moved axially into the bore until the cutting threads 26 contact the anchored material 110. In the use of the apparatus 10′ of FIG. 7, the chamfered leading edge 14a facilitates place of the guide disk 14′ into the bore 112. Referring again generally to the embodiment of FIGS. 1 and 2, because the bore 112 has substantially the same (slightly larger) diameter as the guide disk 14, the bore 112 has a smaller diameter than the major diameter fw of the threads 26. As a consequence, the cutting threads 26 engage the mouth 112a of the bore 112 when guide disk 14 and possibly part of the shaft 12 are inserted. It will be appreciated insertion of the shaft 12′ of the embodiment of FIG. 7 is carried out the same way.

Thereafter, in step 206, the shaft of the anchoring apparatus 10 is rotatably inserted into the bore formed in step 202, such that the at least of the one outer surface threads of the shaft self-taps (i.e. cuts) into the anchoring material 110. Referring to the examples of FIGS. 1 and 4, the shaft 12 is rotatably inserted into the bore 112 such that the cutting threads 26 self-tap into the anchoring material 110, as shown in FIG. 6. To this end, as shown in FIG. 4, a hex tool 118 is inserted into the drive feature 28 and rotated. FIG. 4 shows an example of the hex tool 118 inserted into and engaging the hex drive receptacle 28.

Because the guide disk 14 has an axial length and diameter selected to maintain axial alignment, the rotation of the shaft 12 results in axial movement aligned with the axis R as the threads 26 tap into the walls of the bore 112. The shaft 12 is rotatably inserted until the flange 16 engages the anchoring material 110 in the depression 114. The hex tool 118 is then removed so that the anchoring apparatus 10 is configured to receive a suitable fastener, such as the bolt 102 of FIG. 1 or 2, into the axial bore 22. Because of the depression 114, the proximal surface 30 of the flange 16 can be substantially coplanar with the outer surface 110a of the anchoring material 110, as shown in FIG. 5.

In step 208, the threaded fastener is rotatably inserted into the axial bore of the shaft. In this embodiment the threaded fastener 102 is inserted through the drive feature 28 and into the axial bore 22. When the threads 107 of the shaft 106 engage the threads 24 in the axial bore 22, the threaded fastener 102 is rotatably inserted to the desired axial depth.

With reference to FIG. 5, in many cases, the fastener 102 and anchoring apparatus 10 are used to couple another material, such as anchored material 120, to and against the anchoring material 110. In such a case, step 208 includes inserting the fastener 102 through a through-hole 122 of the anchored material 120 before entering the axial bore 22 through the drive feature 28. FIG. 6 shows a cross-section of the completed method, wherein the anchored material 120 is coupled to and against the anchoring material 110. The cutting threads 26 engage the anchoring material 110 to resist axial pull out force, and the flange 16 provides a surface for stress load transfer and resists torque forces. It will be appreciated that the threaded fastener 102 can be readily removed to separate the anchor material 120, if desired, for example, for replacement.

It will be appreciated that the above-describe embodiments are merely illustrative, and that those of ordinary skill in the art may readily devise their own implementations and modifications that incorporate the principles of the present invention and fall within the spirit and scope thereof.

What is claimed is:

1. An apparatus for anchoring fasteners comprising,
a shaft extending in an axial direction between a proximal end and a distal end, the shaft having an internally threaded axial bore, the shaft having at least one outer surface thread;
a guide disk disposed at the distal end of the shaft and coaxially with the shaft, the first disk having a first diameter that is less than a major diameter of the at least one outer surface thread, and greater than a minor diameter of the at least one outer surface thread;
a flange disposed at the proximal end of the shaft, the flange having a width exceeding the first diameter, the flange including a drive feature configured to engage a drive tool.

2. The apparatus of claim 1, wherein the at least one outer surface thread is eccentric with respect to the axial direction.

3. The apparatus of claim 2, wherein the at least one outer surface thread comprises a plurality of outer surface threads having variable pitches.

4. The apparatus of claim 1, wherein the wherein the flange comprises a disk disposed coaxially with the shaft.

5. The apparatus of claim 4, wherein the flange has a second diameter that exceeds the major diameter of the at least one outer surface thread.

6. The apparatus of claim 5, wherein the drive feature comprises a shaped recess in a top surface of the flange

7. The apparatus of claim 1, wherein the first disk has an axial length exceeding the pitch of the at least one outer surface thread.

8. The apparatus of claim 7, wherein the outer surface of the first disk is substantially cylindrical for the axial length of the disk.

9. The apparatus of claim 8, wherein the outer surface includes an annular chamfer to facilitate insertion of the first disk into a bore having a bore diameter corresponding to the first diameter.

10. The apparatus of claim 7, wherein the first disk has an axial length exceeding one-fourth of the first diameter.

11. The apparatus of claim 1, wherein the drive feature comprises a shaped recess.

12. The apparatus of claim 11, wherein the drive feature comprises a polygonal shaped recess.

13. A method of providing an anchor for a threaded fastener in an anchoring material, the method comprising:
a) forming a first bore in the anchoring material having a first diameter;
b) inserting at least a guide disk of an anchoring apparatus into the first bore, the guide disk having substantially the first diameter, the anchoring apparatus further comprising a shaft having at least one outer surface thread and an axial bore with interior threads, the at least one outer surface thread having a major diameter that exceeds the first diameter;
c) rotatably inserting the shaft such that the at least one outer surface thread cuts into the anchoring material;
d) rotatably inserting the threaded fastener into the axial bore.

14. The method of claim 13, wherein step c) further comprises rotatably inserting the shaft until a flange of the shaft engages the anchoring material, the flange having a width that exceeds the first diameter.

15. The method of claim 14, further comprises, prior to step b) forming a recess for in the anchoring material for receiving the flange, the recess having a diameter that exceeds the first diameter.

16. The method of claim 13, wherein step c) further comprises engaging a tool with a drive features on the flange and using the tool to rotate the shaft.

17. The method of claim 13, wherein step d) further comprises inserting the threaded fastener through a hole in an anchored material before rotatably inserting the threaded fastener into the axial bore.

18. The method of claim 13 wherein the first disk has an axial length exceeding one-fourth of the first diameter.
